(19) United States
(12) Patent Application Publication
(10) Pub. No.: US 2016/0107391 A1
(43) Pub. Date: Apr. 21, 2016

(54) SYSTEM AND METHOD FOR CUSTOM-SIZING BESPOKE SHOES

(71) Applicants: Saerome Bae Parish, New York, NY (US); Joseph Daniel Parish, New York, NY (US)

(72) Inventors: Saerome Bae Parish, New York, NY (US); Joseph Daniel Parish, New York, NY (US)

(21) Appl. No.: 14/519,434

(22) Filed: Oct. 21, 2014

(51) Int. Cl. B29C 67/00; A43D 3/00; A43D 1/02; G05B 19/4099

(52) U.S. Cl. CPC B29C 67/0088; G05B 19/4099; A43D 3/00; A43D 1/025; B33Y 50/02

(57) ABSTRACT

The present invention relates to a system and method for creating custom-made shoes based on a 3D model of a person's foot. Specifically a 3D scanner is used to create a 3D computer model of a person's foot which is stored in a digital file. The 3D computer foot model is then sent to another location. A 3D printer at the other location uses the digital file to print a 3D model of the person's foot. The 3D model is then used make a bespoke shoe specifically fitted to the 3D foot model, or to create one or more custom lasts for making a bespoke shoe.

### FIELD OF THE INVENTION

The present invention relates to a system and method for creating custom-made shoes based on a 3D model of a person's foot. Specifically a 3D scanner is used to create a computer model of a person's foot which is stored in a digital file. The 3D computer foot model is then sent to another location. A 3D printer at the other location uses the digital file to print a 3D model of the person's foot. The 3D model is then used make a bespoke shoe specifically fitted to the foot 3D model, or to create one or more custom lasts for making a bespoke shoe.

### BACKGROUND OF THE INVENTION

Human feet come in a variety of shapes and sizes, making it difficult create shoes that are custom fitted. One traditional approach to this problem has been to create a 3D model of the person's feet, and use that 3D model to create custom shoes specifically tailored to a person's unique feet. The process of creating a 3D model is both time and labor intensive, making this method of manufacturing shoes prohibitively expensive for all but the most wealthy people.

A more economical approach involves measuring a person's feet using a specially designed tool called a Brannock Device. This device has been used since 1927 for measuring feet and finding the correct size of shoes. The measurements from the Brannock Device are recorded and sent to the shoe maker. The shoe maker uses the measurements to choose a pre-manufactured last for creating the shoes. For reference, a last is a physical representation shaped roughly like a human foot which is used to specify the dimensions required to create a specific shape and size of a shoe. In this method, although the specific details and materials can easily be customized for a particular customer, the actual size and shape of the shoe is approximated to a pre-manufactured last that comes reasonably close to the customer's foot size. This is in part because, although useful for standardizing foot measurement methods and foot sizes, the Brannock device cannot fully capture the subtle nuances of a person's foot shape. For example, the height of a person's arch, or the arc created by the lengths of the toes, and the shape of the back of the heel, among other things are all lost on the Brannock Device.

In addition, human feet are often not mirror images of each other. Therefore, when shoes are made in mirror images of each other, one shoe will inevitably fit better than the other. This problem can be slightly alleviated by taking individual measurements of each foot with the Brannock Device, but differences in foot shape between the left and right feet will still not be captured.

Finally, many people have abnormalities, such as corns, bunions, calluses, and ganglion cysts on their feet which make fitting into pre-manufactured shoes difficult or painful. Although making custom shoes to accommodate these various issues is possible, getting the information on exactly how to make a custom shoe that accommodates these issues is difficult.

Therefore, there is a need in the art for a system and method for quickly making a high-accuracy 3D foot model to capture the detailed shape of a person's feet. A preferred method would require very little preparation, materials, time, and labor and cause minimal inconvenience to the customer. These and other features and advantages of the present invention will be explained and will become obvious to one skilled in the art through the summary of the invention that follows.

### SUMMARY OF THE INVENTION

Accordingly, it is an object of the present invention to create a system and method for producing custom fitted shoes based on an exact replica of a customer's feet. The system and method require little to no preparation of a customer's feet, very little material cost, negligible time and labor costs, and only minor inconvenience to the customer.

According to an embodiment of the present invention, a method for creating custom fitted bespoke shoes comprises the steps of: scanning a customer's feet using a 3D scanner to create a 3D computer foot model; receiving design criteria from said customer; printing, using a 3D printer, a 3D model from said 3D computer foot model which is a replica of said customer's feet; and making one or more custom fitted shoes using said design criteria and said 3D model.

According to an embodiment of the present invention, the method further comprises the step of: creating one or more lasts from said 3D model.

According to an embodiment of the present invention, the method further comprises the steps of: creating a pressure map of said customer's feet, said pressure map representing the variations in pressure on said customer's feet; and making one or more custom fitted shoes using said pressure map in addition to said design criteria and said 3D model.

According to an embodiment of the present invention, said design criteria are received from said customer through a web interface.

According to an embodiment of the present invention, a system for creating custom fitted bespoke shoes comprises: a 3D scanner; a 3D printer; a cordwainer; wherein said 3D scanner is configured to scan the feet of a customer to produce a 3D computer foot model; wherein said 3D printer is configured to produce a 3D model of said customer's feet; and wherein said cordwainer creates one or more custom fitted shoes using said 3D model and design criteria provided by said customer.

According to an embodiment of the present invention, the system further comprises: a web interface for receiving design criteria from said customer.

According to an embodiment of the present invention, the system further comprises: a pressure mapping device; wherein said pressure mapping device is configured to create a pressure map representing the variations in pressure on said customer's feet; and wherein said cordwainer creates one or more custom fitted shoes using said pressure map in addition to said design criteria and said 3D model.

According to an embodiment of the present invention, said cordwainer also creates one or more custom lasts from said 3D model.

### BRIEF DESCRIPTION OF THE DRAWINGS

FIG. 1 is a diagram of the system for creating a custom-sized shoes using a model of a customer's feet according to an embodiment of the present invention.

FIG. 2 is a flowchart describing the method for scanning a customer's feet using a 3D scanner to create a 3D computer foot model according to an embodiment of the present invention.

FIG. 3 is a flowchart describing the method for printing a 3D model of a customer's feet and using the model to create a custom-sized bespoke shoe according to an embodiment of the present invention.

### DETAILED SPECIFICATION

The present invention relates to a system and method for creating custom-made shoes based on a 3D model of a person's foot. Specifically a 3D scanner is used to create a 3D computer foot model of a person's foot which is stored in a digital file. The 3D computer foot model is then sent to another location. A 3D printer at the other location uses the 3D computer foot model to print a 3D model of the person's foot. The 3D model is then used make a bespoke shoe specifically fitted to the customer's foot, or to create one or more custom lasts for making a bespoke shoe.

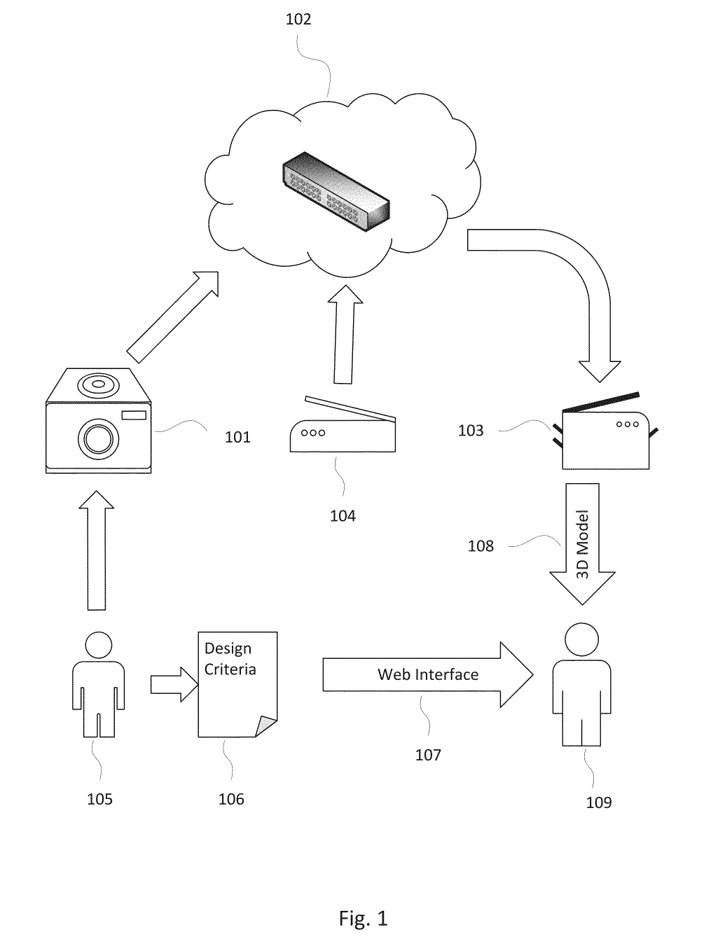

According to an embodiment of the present invention, as shown in FIG. 1, a system for creating a 3D model for making shoes comprises a 3D scanner 101, a communications connection 102, a 3D printer 103, a web interface 107, and a cordwainer 109 (shoe maker). The 3D scanner 101 is used to gather data of a person's feet to produce a 3D computer foot model in the shape of the person's foot. This 3D computer foot model is sent over a communications connection 102 to another location, where a 3D model 108 of the person's feet is reproduced using the 3D printer 103. The 3D model 108 can then be used by the cordwainer 109 to produce custom fitted shoes or one or more custom lasts for creating custom-fitted shoes.

According to a preferred embodiment of the present invention, the other location of the 3D printer is remote, such as overseas, or at a shoemaking factory removed from the location where the customer's feet are scanned by a 3D scanner. In another embodiment of the present invention, the other location of the 3D printer may be within the same building or at a separate location within the same storefront. If the 3D printer and 3D scanner are combined into a single unit, the other location may not even be a physically different location. One or ordinary skill in the art would recognize that any location of 3D printer and 3D scanner could be used without departing from the spirit and scope of the present invention.

According to an embodiment of the present invention, the system may also include a pressure mapping device 104. The pressure mapping device 10 has a pressure sensitive surface. When the user stands on the pressure sensitive surface, the pressure mapping device 104 creates a two-dimensional pressure map of the pressure points on the soles of the feet. This allows a customized sole to be designed to accommodate the unique pressure map of an individual. For example the customized sole may have less material at high pressure points and more material at lower pressure points to even out the pressure applied to the bottom of the foot while walking or standing. This reduces fatigue and increases comfort. As another example, a person with flat feet, or lacking arch support, could then be provided a customized sole which corrects imperfections in foot posture to reduce pain and fatigue, or improve athletic performance and endurance.

According to an embodiment of the present invention, A customer 105 has his or her feet scanned by the 3D scanner 101. The customer 105 may either provide custom shoe design criteria 106 at the time of scanning, or enter the design criteria 106 through a web interface 107. The design criteria 106 may include one or more of: leather type and color, sole material and design, laces, shoe style, shoe model, or finish. The data from scanning the customer's feet is sent to the 3D printer to create a 3D model of the customer's 105 feet. The cordwainer receives both the 3D model 108 and the design criteria 106 and uses them to create one or more custom fitted bespoke shoes.

According to an embodiment of the present invention, the pressure mapping device 104 could be any device designed to create a two-dimensional pressure map either mechanically or electronically and create an electronic file of the pressure map. The pressure mapping device 104 may be combined with the 3D scanner so that all measurements are taken simultaneously. One of ordinary skill in the art would recognize that any pressure mapping device 104 capable of producing an electronic data output could be used without departing from the spirit and scope of the present invention.

According to an embodiment of the present invention, the 3D scanner 101 may use contact or non-contact methods, optical technology, sonar, time of flight, triangulation, conoscopic holography, structured light, modulated light, point clouds, or any other technology for obtaining a 3D model of the person's feet. One or ordinary skill in the art would recognize that any 3D scanning technology could be used to produce a 3D computer foot model of a person's feet without departing from the spirit and scope of the present invention.

According to an embodiment of the present invention, a communications connection 102 may be as simple as a single dedicated connection between two or more devices, a shared connection, a manual network where data is physically carried from one location to another, a local area network (LAN), wide area network, (WAN), cellular communications network (e.g., CDMA, GMS, 3G, 4G, LTE), or any other wired or wireless communications means. One or ordinary skill in the art would recognize that any communications means could be used to move the data from the 3D scanner to the 3D printer without departing from the spirit and scope of the present invention.

According to an embodiment of the present invention, a 3D printer 103 may use extrusion, fused deposition modeling, stereolithography, sintering, CNC, milling or any other additive or subtractive method of producing 3D objects. One of ordinary skill in the art would recognize that any 3D printing technology could be used to produce a 3D model, replica, or reproduction of a person's feet from a digital file without departing from the spirit and scope of the present invention.

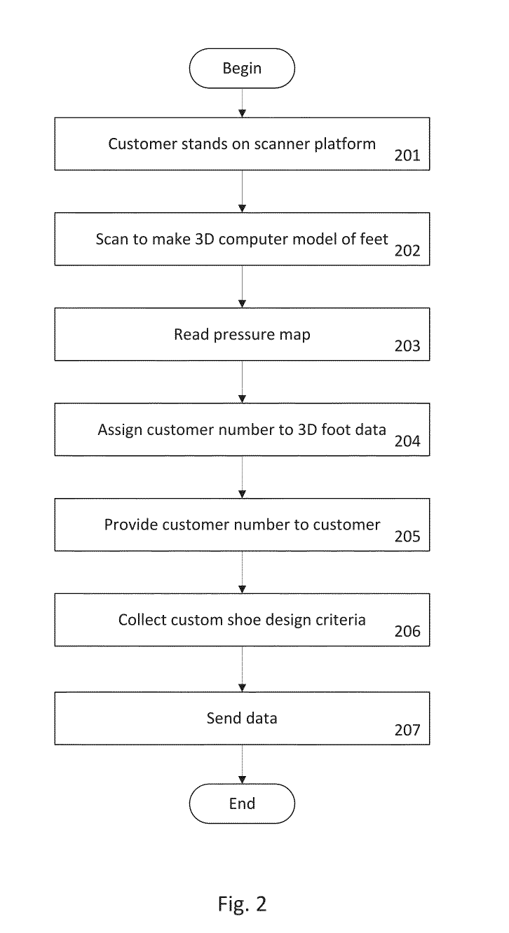

According to an embodiment of the present invention, FIG. 2 shows a flowchart of the process of gathering a 3D foot scan with a pressure map and the custom shoe design criteria 106. At step 201, a customer 105 stands on the 3D scanner 101 platform. The platform may be the area designated where 3D scanning can take place or it may be the pressure sensitive surface of a pressure mapping device 104. At step 202, the 3D scanner 101 scans the feet to create a 3D computer foot model. At step 203, the pressure mapping device, if included, also reads a pressure map of the person's feet. If the pressure mapping device is incorporated into the 3D scanner 101, steps 202 and 203 can be done together. If the pressure mapping device is omitted altogether, step 203 can be skipped.

Still referring to FIG. 2, at step 204, a customer number is assigned to the 3D foot data. This customer number can be any unique identifier that is used to match the 3D foot data to the design criteria 106 provided by the customer 105. This customer number is provided to the customer 105 at step 205 so that the customer 105 can enter it into the web interface, or otherwise use it to identify the design criteria 106 when and if the design criteria 106 are provided at a later time. If the customer provides design criteria 106 through some other means, such as a web interface 107 before using the 3D scanner 101, the customer number will have already been assigned. In this case, the customer number is received from the customer and associated with the 3D computer model data at the time of scanning.

Still referring to FIG. 2, at step 206, the custom shoe design criteria are gathered. This step need not be performed at any particular time, and may be performed before or after scanning the feet or even at a separate time, or separate location. The custom shoe design criteria can also be collected online through a web interface. At step 207, the 3D computer model data is sent to another location to be used to reproduce a 3D model 108 of the customer's 105 feet.

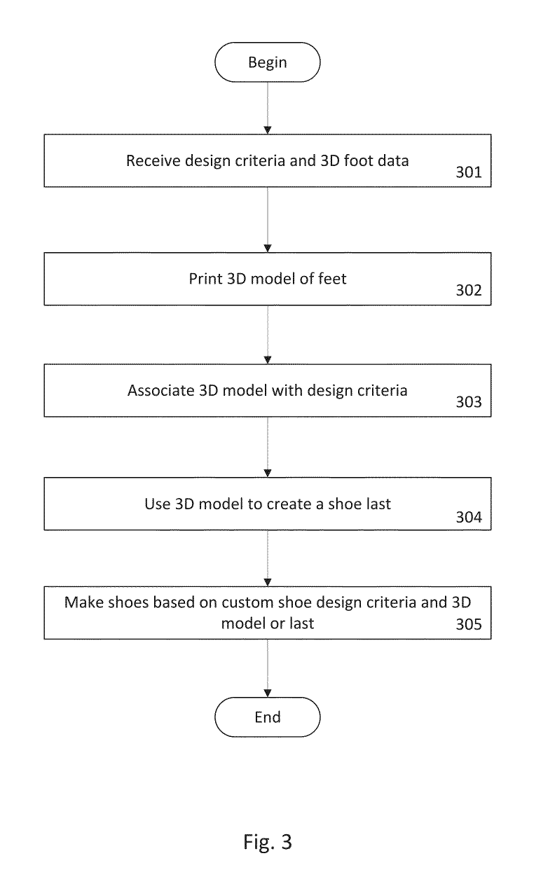

According to an embodiment of the present invention, FIG. 3 shows a flowchart of the process for receiving data and design criteria for creating bespoke shoes that are custom fitted to a customer's 105 feet. At Step 301, the design criteria 106 and or the 3D computer model data are received. The design criteria and 3D foot data need not be received at the same time or through the same process. The 3D foot data can be received as a communication from the location of the 3D scanner while the design criteria may be entered by the customer through a web interface. At step 302, the 3D printer prints, carves, cuts, or otherwise produces the 3D model of the feet. At step 303, the 3D model and design criteria 106 are associated with each other through the customer number. In one embodiment of the invention, the customer number is printed on the 3D model 108 of the customers feet and also displayed or printed on the design criteria 106 so they can be associated with each other. In another embodiment, the customer number is stored electronically, such as on an RFID tag or flash memory embedded in the 3D model. This allows the 3D model to be retrieved by an automated system when additional pairs of shoes are required for a previous customer 105.

Still referring to FIG. 3, at step 304, shoe makers create one or more shoe lasts using the 3D printed foot model. This step is optional, but can be helpful for creating different types of shoes such as boots, athletic shoes, high heels, swimming fins, or other types of specialized footwear. Each type of footwear may have design characteristics which are common to the type of footwear regardless of the size or shape of the foot. Creating a last for a particular footwear type allows the shoe makers to maintain a consistent fit across multiple pairs of shoes when additional shoes of the same type are required for the same set of feet. At step 305, a shoe maker, or cordwainer, creates one or more shoes based on the design criteria and the 3D foot model or last.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

While the invention has been thus described with reference to the embodiments, it will be readily understood by those skilled in the art that equivalents may be substituted for the various elements and modifications made without departing from the spirit and scope of the invention. It is to be understood that all technical and scientific terms used in the present invention have the same meaning as commonly understood by one of ordinary skill in the art to which this invention belongs unless otherwise stated. Accordingly, the drawings and descriptions are to be regarded as illustrative in nature and not restrictive.

1. A method for creating custom fitted bespoke shoes comprising:
scanning a customer's feet using a 3D scanner to create a 3D computer foot model;
receiving design criteria from said customer;
printing, using a 3D printer, a 3D model from said 3D computer foot model which is a replica of said customer's feet; and
making one or more custom fitted shoes using said design criteria and said 3D model.

2. The method of claim 1 further comprising:
creating one or more lasts from said 3D model.

3. The method of claim 1 further comprising:
creating a pressure map of said customer's feet, said pressure map representing the variations in pressure on said customer's feet; and
making one or more custom fitted shoes using said pressure map in addition to said design criteria and said 3D model.

4. The method of claim 1 wherein said design criteria are received from said customer through a web interface.

5. A system for creating custom fitted bespoke shoes comprising:
a 3D scanner;
a 3D printer;
a cordwainer;
wherein said 3D scanner is configured to scan the feet of a customer to produce a 3D computer foot model;
wherein said 3D printer is configured to produce a 3D model of said customer's feet; and
wherein said cordwainer creates one or more custom fitted shoes using said 3D model and design criteria provided by said customer.

6. The system of claim 5 further comprising:
a web interface for receiving design criteria from said customer.

7. The system of claim 5 further comprising:
a pressure mapping device;
wherein said pressure mapping device is configured to create a pressure map representing the variations in pressure on said customer's feet; and
wherein said cordwainer creates one or more custom fitted shoes using said pressure map in addition to said design criteria and said 3D model.

8. The system of claim 5 wherein said cordwainer also creates one or more custom lasts from said 3D model.
